(19) United States
(12) Patent Application Publication
(10) Pub. No.: US 2016/0380372 A1
(43) Pub. Date: Dec. 29, 2016

(54) Electrical Connector for USB and other external interface and method of making

(71) Applicants: Ching-Ho Hsieh, Tao-Yuan City (TW); Bohdan P. Wozniak, Warrington, PA (US); David L. Chen, Los Altos, CA (US); Chih-Peng Fan, Tao-Yuan City (TW); Ming-Hsing Wu, Tao-Yuan City (TW)

(72) Inventors: Ching-Ho Hsieh, Tao-Yuan City (TW); Bohdan P. Wozniak, Warrington, PA (US); David L. Chen, Los Altos, CA (US); Chih-Peng Fan, Tao-Yuan City (TW); Ming-Hsing Wu, Tao-Yuan City (TW)

(21) Appl. No.: 15/192,015

(22) Filed: Jun. 24, 2016

Related U.S. Application Data
(60) Provisional application No. 62/183,896, filed on Jun. 24, 2015.

(51) Int. Cl. H01R 12/75; H01R 24/60; H01R 13/26; H01R 13/11; H01R 43/20

(52) U.S. Cl. CPC H01R 12/75; H01R 13/11; H01R 43/20; H01R 13/26; H01R 24/60; H01R 2107/00

(57) ABSTRACT

A novel interconnection structure and method of manufacture is provided which provides an improved means of interconnecting external connector interfaces, such as Universal Serial Bus (USB) connectors, to the internal system boards of electronic devices, such as laptop computers, tablets, and mobile phones. An external connector interface used for interconnecting separate electronic devices is connected to the internal system board of the device in which it resides by being interconnected mechanically and electrically, or alternatively being integral to and of a unitary structure with, a printed circuit substrate, said printed circuit substrate having a plurality of conductive, elastic spring contacts mounted on one surface, with at least one of said electrical spring contacts electrically interconnected to the external electrical connections of the USB connector, and said electrical spring contacts providing an electrical interconnection means to a system board inside the electronic device.

This structure improves upon the state of the art by reducing the number and complexity of interconnection interfaces, reducing signal degradation, allowing higher data transfer rates, and improving reliability of the interconnections.

The interconnection of the USB substrate to the system board may be separable, re-mountable, and re-connectable, and may be accomplished with a normal-force actuated connector.

### CROSS REFERENCE TO RELATED PATENT

This patent claims the benefit of provisional patent application Ser. No. 62/183,896 filed Jun. 24, 2015 entitled “High Data Rate System Interconnection for USB and other external interface connection in electronic devices”, the specification and drawings of which are hereby incorporated herein by reference.

### BACKGROUND

Field of the Invention

The present invention relates to improved electrical and mechanical interconnection interfaces for integrating external Universal Serial Bus (USB) connector interfaces and other external interfaces into electronic systems such as personal computers, laptop computers, tablets, and mobile phones.

Background of the Invention

Complex electronic devices such as computers, laptop computers, workstations, servers, tablets, mobile phones, printers, routers, and other devices require electrical interconnection to other devices. For example, standardized USB and micro-USB interconnections are commonly used to interconnect a computer to printers, to the computer mouse, to keyboards, to external storage devices, and to other electronic devices including other computers, cell phones, cameras, and the like. USB 1.0, 2.0, 3.0 and 3.1 are common standardized USB connections. Over time, these interconnections are evolving to enable much faster data transfer with better signal integrity and greater ability to carry higher current and power for charging and powering devices. Over time, undoubtedly other releases of USB interfaces and other external electrical and optical interconnections for connecting electronic systems to other electronic devices will be developed. Typically, it is desired that these external interconnections be separable in order to facilitate ease of interchanging the devices connected to a system, or removal of the devices for packing and transporting of the devices.

However, the USB or other external interface in an electronic system must be interconnected to the system (for example, laptop or desktop computer) in a permanent or semi-permanent manner. The interconnection must be robust mechanically and electrically, because these interconnections may be mated and un-mated hundreds or thousands of times, in some cases, during the life of the system, which may transfer stresses to the internal interconnections of the external interface connector. Because of the increasing rates of data transfer desired by users of these devices through these electronic interfaces, and the evolving capabilities of the external interfaces to carry data at higher speeds and to carry more power, the signal integrity and current capacity of the electrical interconnections between the external interface and the primary system of which it is a part must improve to keep pace.

Many times, these external electrical interfaces, such as USB connectors, have a rigid printed circuit substrate comprising a plurality mating contacts for interconnecting to the other mating half of the USB connector such as would be found on a USB cable from a secondary electronic device or on a flash drive. Most commonly, this printed circuit substrate is separate and distinct from the system mother board, and frequently it's only function is to provide the USB connector external interface and to provide a second interface to interconnect that external interface to the primary electronic device. The USB printed circuit substrate is distinct from the mother board for a variety of reasons, including minimizing mother board size and therefore cost, since the mother board in these electronic devices can be highly complex, multi-layer circuit substrates, whereas, for example, a USB printed circuit substrate can often be much simpler in construction. Further, if the USB connector had a malfunction, it could be replaced or repaired without replacing or removing the mother board from the device. The external interface connections to the external USB cable are commonly made via connection terminals on the printed circuit substrate, said terminals commonly comprising copper bond fingers which are coplanar with the substrate surfaces, and which are plated with a barrier metal such as nickel which itself is commonly plated with a noble, corrosion and wear resistant metal such as hard gold.

While these external interfaces, such as USB interfaces, are commonly standardized across the electronics industries, some equipment designers and manufacturers create their own unique and sometimes proprietary external electrical interconnection interfaces. In subsequent discussions, for simplicity, the terms external electrical interface, external interface, USB, USB connector, or USB interface may be used where the discussion and description also applies to and is intended to refer to other standard and non-standard interfaces including unique interfaces of specific system designers and manufacturers, as well as to future types of these various types of external electronic data, or data and power, interconnection interfaces as they may be developed.

In some cases, the external interface substrate, such as the printed circuit substrate in a USB connector, is mounted into an opening in the chassis or case of the electronic system. Often, there is a USB receptacle mounted on the printed circuit substrate, surrounding the interconnection terminals on that substrate that will ultimately mate to the external USB connector cable. In other cases, the USB connector has a first circuit substrate comprising the conductive terminals to connect to the second mating half of the USB connector, a housing surrounding this first circuit substrate, and a second set of terminals connected to the first set of external interface conductive terminals, the second set of terminals being adapted to interconnect to a second printed circuit substrate, such as a USB card or a daughter card in the electronic system. The adaptation may include pins for pin-in-hole soldering to a USB card or daughter card, or they may include surface mount pads for surface mount soldering of the USB connector to a USB card or daughter card. In standardized formats such as USB 3.1, the dimensions and geometries of the connection terminals on the circuit substrate, and the portion of the circuit substrate upon which these terminals reside, and also the shape and size of the housing and it's position relative to the terminals, is tightly controlled. There would typically be an opening in the case or housing of the electronic device in which the USB housing would reside, and an affixing means to maintain its position in that opening. The housing described here would provide a means for alignment of the other half of the USB connector residing in a USB cable connected to an external electronic device, or in another device such as a flash drive, during the mating of the second half of the USB connector to the electronic system's USB connector half. In other devices, the housing or case of the electronic device may serve as the connector housing, and the printed circuit substrate, and particularly the USB electrical interconnection terminals on that printed circuit substrate, would be accurately aligned to the opening in the case, and a means would be provided for affixing the USB circuit substrate to the case in accurate and precise alignment to the opening.

These external electrical interconnection interfaces, such as USB connectors or other interfaces, must also have an internal electrical interconnection to the system of which it is a part, such as a laptop or desktop computer, so that the external device can communicate and receive or provide power from or to the primary system (laptop or desktop computer in this example). This internal interconnection of the external interface to the system is frequently not standardized, such that many manufacturers have their own unique internal interconnection design. Typically, however, the system manufacturers design this internal interface to be separable and re-connectable, so that repair or replacement of the external interface, if necessary, can be easily performed, and to simplify assembly, testing, rework and repair of the system and its interfaces. In some instances, a flexible printed circuit (flex circuit or flex cable) is used to form the electrical connection between the USB connector substrate or card and a system circuit board such as a mother board.

The flex circuit enables the USB connector substrate and the mother board to be located remotely from each other and various orientations can be accommodated due to the ability to bend the flexible printed circuit, but it adds a substantial amount of cost. In these instances, the flexible printed circuit is commonly interconnected to the mother board with a separable electrical connector. Frequently, this separable connector is a two piece, mezzanine-type surface mount connector, whereby there may be a connector socket or receptacle mounted on and interconnected to (frequently with soldered electrical connections) connection terminals on the flex circuit at the end to be connected to the mother board, and a mating header mounted accordingly directly to the mother board. (Alternatively, the socket may be on the mother board and the header on the flex circuit). In other, less common instances, a zero insertion force (ZIF) one piece connector may be used for this interconnection. Commonly, the other end of the flex circuit is similarly mated to the USB connector printed circuit substrate using a similar or identical two piece mezzanine, surface mount connector, or a ZIF connector. In this common example, the cost of a USB external interface (or port) includes the cost of the USB connector itself, but also the cost of the flex cable and of the two connector pairs used for the internal interconnections. In addition, this approach increases the number of interfaces subject to potential malfunction or reliability failure. These connector interfaces also typically are a source of signal distortion, due to impedance discontinuities and high inductance within the connector spring contacts, and can limit the data transfer speed through the USB interconnection. Further, these types of connectors can most frequently only carry low amounts of current (for example, 0.2 to 0.3 amps per contact), and therefore USB interfaces to external devices with higher power requirements can increase the number of electrical contacts required in the connectors to handle the power demand, and therefore the area of the connector footprint and the area required on the printed circuit board and the USB connector substrate, which increases the cost of all three elements.

In other cases, the USB connector assembly may be soldered directly to a daughter card, which in turn must be interconnected to the mother board of the system, as with a flex circuit with connectors. In other cases, the USB connector may be mounted directly onto a mother board, but in this instance, the positioning of the mother board must be tightly controlled relative to the USB port in the system case.

Furthermore, the internal electrical interconnection approaches commonly used, such as those described in the preceding paragraphs, do not provide a means for mechanical affixing of the USB connector (including the USB printed circuit substrate and the housing, if included) to the system housing or case, and therefore a separate affixing means is necessary and adds further complexity and cost to the design and manufacture of each individual USB or other external interface port or connector in an electronic system.

While there are other interconnection schemes that may also be used, with or without a flex circuit, they typically suffer from all or some of the above drawbacks.

As these electronic devices evolve to provide increased functionality in smaller form factors and in thinner profiles, such as for mobile consumer electronic products, the external electrical interface connectors must simultaneously improve in function and performance while decreasing in size, including area of the connector's footprint (x by y area occupied on the mating circuit elements for the connection to the USB or other cable and for the internal interconnections to the system) and its profile (thickness). The internal connection between the external electrical interconnection interface and the system electronics (such as the mother board of a laptop computer) must also keep pace with system miniaturization as well as with the increasing demand for high signal integrity at high data rates and higher power interconnections.

It is frequently required that electrical connectors in electronic devices meet stringent performance requirements, such as maintaining high signal integrity of the interconnected electronic signals at high operating frequencies, providing low electrical contact resistance to enable high current capacity with minimal temperature rise, surviving high levels of mechanical shock and vibration without transient or permanent interruptions in the electrical path, maintaining reliable interconnections through various environmental stresses during life of the product, and meeting other stringent performance requirements that are specific to various applications such as aerospace, medical electronics, and other demanding applications. In the case of external electrical interconnection interfaces, its internal interconnection to the system electronics must meet the same stringent performance and reliability requirements. As electronic devices continue to be miniaturized, the interconnection terminals or pads on the circuit elements being interconnected frequently are required to be reduced in size (area) and located on finer pitches (spaced closer together), requiring electrical connectors with improved means for precise and accurate alignment to the circuit elements and with very accurate true position of the contacts in the connector relative to each other and to the position of these alignment means. Manufacturing costs of these connectors must be low to keep pace with the competitive environment and end product pricing constraints, so connector materials and manufacturing processes must be simple, streamlined and/or low cost.

For these reasons and others, improvements are needed in the available means of providing the internal electrical interconnection from external electrical interfaces, such as USB connectors, to the system electronics, such as a computer mother board.

As described above, many connectors used in present miniaturized electronic devices to interconnect USB connectors or other external electrical interfaces to the system electronics fall into one of two general categories: two piece ‘mezzanine’ connectors, and one piece ‘ZIF’ connectors. Both ZIF and mezzanine connectors frequently have difficulty surviving mechanical shocks and vibrations without transient or permanent interruptions in the electrical path, unless secondary retention elements are included which occupy additional space in the device. Since space in miniaturized devices is at a premium, this is not ideal. As these connectors continue to be miniaturized, the sensitivity to shock and vibration typically increases due to less area for application of retention forces. Typically the profile thickness of these connectors is well above 1 millimeter, which can be a limiting factor in shrinking the thickness of devices like high end mobile ‘smart-phones’. Commonly, common ZIF and mezzanine connectors contribute to a reduction in signal fidelity at high frequencies due to relatively long, high inductance leads, and/or due to impedance discontinuities at the transitions from the mating circuit element terminals to the connector's electrical contacts. Frequently, the power handling capacity of these two connector types is less than or equal to 0.3 amps of current per individual contact due to high contact resistance and long current path, requiring an increase in the number of power contacts and an increased separation of these power contacts to enhance power dissipation and prevent overheating, and thus an increase in the connector's footprint size is frequently required in order to function effectively as high power internal connectors for interfacing to USB or other external ports providing power to external devices. In addition, contact true position of these connectors is frequently inadequate to enable the desired level of miniaturization in the system and of the circuit elements in the system. In many cases, these connectors are manufactured by stamping and forming electrical spring contacts into separate contact elements, before or during the insertion of those contacts sequentially into a pre-molded connector housing. In this situation, the true position tolerance of the contacts is defined cumulatively by any inaccuracies of the insertion process and inaccuracies in the precision of various dimensions of the molded connector housing structures that align and retain the electrical spring contacts, as well as inaccuracies in the dimensions or shape of the formed spring contacts and of the insertion process. In addition, the insertion process is sequential and thus relatively time consuming and expensive, compared to batch processes. The retention of the contacts in the housing and their position is maintained by frictional forces, rather than by true bonding of the contacts to the connector housing as would be the case if the housing were molded directly onto a portion of the contacts. It is desirable and would be an advance over the current state of the art to provide a connector structure and manufacturing process that offers high signal fidelity, high mechanical and electrical spring compliance and working range, high resistance to mechanical shock and vibration, fine contact pitch, low connector profile, high current capacity, very accurate and repeatable contact true position, low cost batch manufacturing processes, and reliability through environmental stresses during operating life in one connector type.

### SUMMARY OF INVENTION

One objective of this invention is to provide an improved external interface connector structure and method of manufacture and integration, such as an improved USB connector that is more easily manufactured and integrated at the system level. Another objective of this invention is to provide an improved interconnection structure and method to electrically interconnect an electrical or opto-electronic external interface connector that is used for interfacing between an electronic device or system and a separate, external electronic device or system, to other circuit elements in the electronic device, such as the mother board or a daughter card. Yet another objective of the present invention is to provide an improved means of interconnecting an external electronic or electrical interconnection interface, such as a USB connector interface, of an electronic device, to the internal electronics of the electronic device or system, and which provides one or more of the following benefits including improved electrical performance, low electrical resistance, high signal fidelity at high operating frequencies and high data transfer rates, high current carrying capacity with low temperature rise, high mechanical and electrical compliance and working range of the electrical spring contacts for high tolerance of mechanical shock and vibration without suffering transient or permanent electrical opens, fine contact pitch for small connector footprint, positive retention and ease of assembly, fewer interconnection interfaces for improved reliability and reduced impedance discontinuities, improved miniaturization in footprint and profile, improved ease of system assembly, testing, rework and repair, and a simplified means for mechanically affixing the USB port to the system housing and USP port opening with sufficiently precise alignment.

Another objective of the invention is to maintain very tight true position tolerances for the electrical contacts in such an internal interconnection connector for an external interface device such as a USB connector, relative to each other and to alignment features on the connector body, so that it is capable of interconnecting miniaturized interconnection terminals of small size and/or on a tight pitch on both the mother board and on the substrate of the external electrical interconnection interface to reduce space required and reduce cost of these elements.

It is a further objective of this invention to provide the above capabilities with an interconnection system which can be manufactured in relatively few process steps and at lower cost than commonly used connectors, including by mass stamping and forming of the electrical spring contacts and mass integration of these electrical contacts into the substrate of an electronic systems external electronic interfaces, such as USB connectors, and by other batch processing methods including surface finishing and singulation so that cost is low.

It is a further objective of this invention to provide a means for integrating the internal electrical interconnection means directly into the substrate of the USB connector or other external electrical interconnection interface, or directly into a substrate onto which the USB connector is mounted, said mounting being accomplished by such means as surface mount soldering, pin in hole soldering, conductive adhesive mounting, or other means. For the purposes of simplicity, the terms USB connector, external connector, external electrical interconnection, and external electrical interconnection interface may be used interchangeably. In addition, they are intended to refer more generally to a variety of electrical and opto-electronic data and power interfaces between an electronic device or system and external devices including but not limited to those described in the background section of this application. These external interfaces can include, but are not limited to, USB and Micro-USB connectors.

In one embodiment of the present invention, a USB connector is mounted mechanically, and interconnected electrically, to a printed circuit substrate, said printed circuit substrate having a plurality of conductive, elastic spring contacts mounted on one surface, with at least one of said electrical spring contacts electrically interconnected to the external electrical connections of the USB connector, and said electrical spring contacts providing an electrical interconnection means to a system board inside an electronic device such as a computer, laptop computer, tablet, or mobile phone, or other device that may require external electrical interconnection interfaces.

In another embodiment of the present invention, a USB connector is mounted mechanically, and interconnected electrically, to a printed circuit substrate using surface mount soldering, said printed circuit substrate having a plurality of conductive, elastic spring contacts mounted on one surface, with at least one of said electrical spring contacts electrically interconnected to the external electrical connections of the USB connector, and said electrical spring contacts providing an electrical interconnection means to a system board inside an electronic device such as a computer, laptop computer, tablet, or mobile phone, or other device that may require external electrical interconnection interfaces.

In another embodiment of the present invention, a USB connector is mounted mechanically, and interconnected electrically, to a printed circuit substrate using pin-in-hole soldering, said printed circuit substrate having a plurality of conductive, elastic spring contacts mounted on one surface, with at least one of said electrical spring contacts electrically interconnected to the external electrical connections of the USB connector, and said electrical spring contacts providing an electrical interconnection means to a system board inside an electronic device such as a computer, laptop computer, tablet, or mobile phone, or other device that may require external electrical interconnection interfaces.

In another embodiment of the present invention, a USB connector is mounted mechanically, and interconnected electrically, to a printed circuit substrate, said printed circuit substrate having a cut-out region that provides clearance such that the male connector tab of the USB connector, which is centered in the USB connector housing, is approximately co-planar with the printed circuit substrate, and such that the USB connector housing projects above both the first surface and the opposing second surface of the printed circuit substrate, said printed circuit substrate having a plurality of conductive, elastic spring contacts mounted on one surface, with at least one of said electrical spring contacts electrically interconnected to the external electrical connections of the USB connector, and said electrical spring contacts providing an electrical interconnection means to a system board inside an electronic device such as a computer, laptop computer, tablet, or mobile phone, or other device that may require external electrical interconnection interfaces.

In another embodiment of the present invention, the standard internal substrate of a male USB connector half for an electronic device, on which the conductive terminals for external interconnection of the connector reside, is an extension of, and a unitary structure with, a printed circuit substrate which extends beyond the external facing half of the USB connector, said printed circuit substrate having a plurality of conductive, elastic spring contacts mounted on one surface, with at least one of said electrical spring contacts electrically interconnected to the external electrical connections of the USB connector through one or more conductive traces on the printed circuit substrate, and said electrical spring contacts providing an electrical interconnection means to a system board inside an electronic device such as a computer, laptop computer, tablet, or mobile phone, or other device that may require external electrical interconnection interfaces.

In another embodiment of the present invention, the standard internal substrate of a male USB connector half for an electronic device, on which the conductive terminals for external interconnection of the connector reside, is an extension of, and a unitary structure with, a printed circuit substrate which extends beyond the external facing half of the USB connector, said printed circuit substrate having a plurality of conductive, elastic spring contacts mounted on one surface, with at least one of said electrical spring contacts electrically interconnected to the external electrical connections of the USB connector through one or more conductive traces and one or more conductive through vias on the printed circuit substrate, and said electrical spring contacts providing an electrical interconnection means to a system board inside an electronic device such as a computer, laptop computer, tablet, or mobile phone, or other device that may require external electrical interconnection interfaces.

### BRIEF DESCRIPTION OF THE DRAWINGS

FIG. 1 shows a photograph of an external view of a prior art USB connector in an electronic device.

FIG. 2 shows a photograph of an internal view of a prior art USB connector, and its interface to an electronic system.

FIG. 3 shows a photograph of another perspective of a prior art USB connector and its interface to an electronic system.

FIG. 4 shows a drawing of a perspective view of one side of a USB connector of the present invention, the substrate of the USB connector having integral spring contact elements for interconnection directly to an internal system board.

FIG. 5 shows a drawing of an opposite side of the USB connector shown in FIG. 4, including a stiffener mounted on a portion of the USB connector substrate.

FIG. 6 shows a drawing of an expanded view of 4 of the elastic spring contacts shown in FIG. 4.

FIG. 7 shows a view of the USB connector of FIG. 4 integrated into an electronic device.

FIG. 8 shows a drawing of a perspective view of another embodiment of the present invention, whereby a USB connector connector and housing is mounted on and interconnected to a printed circuit substrate having elastic, conductive spring contacts on the bottom surface for direct interconnection to a system board in an electronic device.

FIG. 9 shows a drawing of a profile view of the USB connector assembly shown in FIG. 8.

FIG. 10 shows a drawing of the bottom side of the USB connector assembly shown in FIG. 8.

FIG. 11 shows a drawing of a perspective view of one means of interconnecting the connector shown in FIG. 8 to a system board in an electronic device, including the mating external USB cable assembly.

FIG. 12 shows a diagram of possible pin assignments for the electrical spring contacts of the integral, internal interface connector of the USB connector assembly shown in FIG. 6.

FIG. 13 shows a schematic drawing of one possible configuration of the interconnection terminals on a printed circuit substrate for mounting of a USB connector and electrically interconnecting it to the substrate using surface mount attachment.

FIG. 14 shows a perspective drawing of another embodiment of the present invention, where a USB connector receptacle and housing is mounted on and interconnected to a printed circuit substrate having elastic, conductive spring contacts on the bottom surface for direct interconnection to a system board in an electronic device, and where the USB housing is located in a cut out in the printed circuit substrate to allow a lower profile connector.

FIG. 16 shows a drawing illustrating another embodiment of the present invention where a USB Type C connector is surface mounted directly to a flexible printed circuit, whereby the FPC has conductive spring contacts on the bottom surface for direct interconnection to a system board in an electronic device.

One aspect of the present invention comprises a USB connector having a printed circuit substrate with standard USB connector conductive interconnection terminals at one end residing within a standard USB housing affixed to and in standardized alignment with the substrate terminals such that it could form an electrical interconnection with a connector end of a standard USB cable or connector half when mated, and having a plurality of conductive, elastic spring contact elements emanating from a first surface of the substrate at another end of the substrate, at least one of the conductive spring contact elements electrically connected to at least one of the USB conductive interconnection terminals, and whereby the elastic spring contact elements can be mated to conductive terminals on an electronic circuit element such as a system mother board, daughter card, or flexible printed circuit, using normal force. In one embodiment, the elastic spring contact elements are cantilever beam-like spring contacts. In another embodiment, the elastic spring contact elements are PCBeam spring contacts as taught in US patents assigned to Neoconix, Inc. including U.S. Pat. Nos. 7,371,073 B2 and 8,584,353.

Another embodiment of the present invention comprises a USB connector having a printed circuit substrate with standard USB connector conductive interconnection terminals at one end residing within a standard USB housing affixed to and in standardized alignment with the substrate terminals such that it could form an electrical interconnection with a connector end of a standard USB connector on a cable, or a device such as a USB flash drive, when mated, and having a plurality of conductive, elastic spring contact elements emanating from a first surface of the substrate at an opposite end of the substrate, at least one of the conductive spring contact elements electrically connected to at least one of the USB conductive interconnection terminals, and whereby the USB connector substrate is electrically mated to a system board such as a mother board or daughter card by normal force compression of the spring contacts against mating conductive terminals on the system board, and whereby the normal force is applied and maintained using at least one screw. In another related embodiment, the normal force is applied and maintained using spring loaded, latched clamping mechanism.

In another embodiment of the present invention, a USB connector comprises a printed circuit substrate with USB connector conductive terminals, a USB connector housing aligned to the terminals, and electrical spring contacts integral to the substrate which form an electrical interconnection to a system board such as a mother board when aligned to interconnection terminals on the system board and normal force is applied, where at least one of the electrical spring contacts is connected to at least one of the USB connector conductive terminals by a conductive printed circuit trace. In another related embodiment, these spring contacts are designed to be compressed and to form electrical interconnections to mating pads on a mating substrate by applying normal force between the substrate and the mating circuit board. In another related embodiment, these spring contacts are cantilever beam-like, electrically conductive springs. In another related embodiment, the spring contact is connected to the conductive printed circuit trace on the USB connector substrate using metal plating. In another related embodiment, the spring contact is connected to the conductive printed circuit trace on the USB connector substrate using a fusible metal, such as a solder. In another related embodiment, the spring contacts are cantilever beam-like contacts, the contact comprising a base end which is adhered to the USB connector substrate, and a distal end which emanates from the surface of the substrate and which is elastic. In another related embodiment, the distal end of the contact emanates from the surface of the USB connector substrate, through an opening in a second dielectric layer adhered to the USB connector substrate and which overlaps the base end of the contacts, such that when fully compressed, the distal end of the contact is fully contained in the opening of the second dielectric layer, and this dielectric layer prevents over-compression of the spring when it bottoms out against the surface of the mating circuit element inside of the electrical system, such as the system mother board. Another embodiment of the present invention comprises a USB connector having a printed circuit substrate within it, whereby the substrate includes electrical connection terminals at one end on at least a first surface, said connection terminals providing the mating interconnection terminals in the USB connector for mating to an external electronic device via a USB cable and/or mating connector, and also comprising a USB connector housing aligned to the mating interconnection terminals and affixed to the printed circuit substrate, and whereby there is a plurality of normal force, conductive elastic spring contacts integral to and emanating from a first or a second surface of the printed circuit substrate of the USB connector, whereby at least one conductive, elastic spring contact is electrically connected to at least one USB interconnection terminal by a printed circuit trace, and whereby the electrical connection between the elastic spring contact and the printed circuit trace is achieved by metal plating. In another related embodiment, the distal end of the contact emanates from the surface of the USB connector substrate, through an opening in a second dielectric layer adhered to the USB connector substrate and which overlaps the base end of the contacts, such that when fully compressed, the distal end of the contact is fully contained in the opening of the second dielectric layer, and this dielectric layer prevents over-compression of the spring when it bottoms out against the surface of the mating circuit element inside of the electrical system, such as the system mother board.

Another embodiment of the present invention comprises a USB connector having a printed circuit substrate within it, whereby the substrate includes electrical connection terminals at one end on at least a first surface, said connection terminals providing the mating interconnection terminals in the USB connector for mating to an external electronic device via a mating USB connector, and whereby there is a plurality of normal force, conductive elastic spring contacts integral to and emanating from at least a first or a second surface of the printed circuit substrate of the USB connector, whereby at least one conductive, elastic spring contact is electrically connected to at least one USB interconnection terminal by a printed circuit trace, and whereby the electrical connection between the elastic spring contact and the printed circuit trace is achieved by metal plating. In a related embodiment, the case or housing of the electronic device containing the USB connector substrate has a penetration through it, said penetration comprising an opening with the same dimensions as a standard USB connector housing, whereby the USB connector substrate and USB interconnection terminals on the substrate are precisely aligned to the opening so that it functions as the USB connector housing, enabling precise and repeatable alignment of a mating USB connector device to it for electrical interconnection to an external electronic device such as a flash drive, an external hard drive, a printer, or other external electronic device.

Another embodiment of the present invention comprises a USB connector having a printed circuit substrate within it, whereby the substrate includes electrical connection terminals at one end on at least a first surface, said connection terminals providing the mating interconnection terminals in the USB connector for mating to an external electronic device via a mating USB connector half, and whereby there is a plurality of normal force, conductive elastic spring contacts integral to and emanating from a first or a second surface of the printed circuit substrate of the USB connector, whereby at least one conductive, elastic spring contact is electrically connected to at least one USB interconnection terminal by a printed circuit trace, and whereby the electrical connection between the elastic spring contact and the printed circuit trace is achieved by metal plating.

Another embodiment of the present invention comprises a USB connector having a printed circuit substrate within it, whereby the substrate includes electrical connection terminals at one end on at least a first surface, said connection terminals providing the mating interconnection terminals in the USB connector for mating to an external electronic device via a USB cable or other USB mating connector, and whereby there is a plurality of normal force, conductive elastic spring contacts integral to and emanating from a first or a second surface of the printed circuit substrate of the USB connector, whereby at least one conductive, elastic spring contact is electrically connected to at least one USB interconnection terminal by a printed circuit trace, and whereby the electrical connection between the elastic spring contact and the printed circuit trace is achieved by metal plating.

In another embodiment of the present invention, a USB connector comprised of a printed circuit substrate, an external connection end of the printed circuit substrate with interconnection terminals for making a connection to a mating USB connector half, a USB housing precisely aligned to the external connection end and the interconnection terminals thereon, whereby the USB connector substrate is directly electrically and mechanically interconnected to an internal system board in an electronic device using normal force, conductive contact springs directly integrated into the USB connector substrate aligned to and compressed against conductive terminal pads on the internal system board. In a related embodiment, the normal force is applied using at least one screw to clamp the USB substrate against the system board.

In another embodiment of the present invention, a USB connector comprised of a printed circuit substrate, an external connection end of the printed circuit substrate with interconnection terminals for making a connection to a mating USB connector half, a USB housing precisely aligned to the external connection end and the interconnection terminals thereon, whereby the USB connector substrate is directly electrically and mechanically interconnected to an internal system board in an electronic device using a single piece, normal force connector inserted between the USB connector substrate and the system board. In a related embodiment, the single piece, normal force connector has a plurality of electrical contact springs emanating from a both a first surface and a second opposing surface of the normal force connector, and where at least one electrical contact spring on the first surface is electrically connected to at least one electrical contact spring on the second surface. In a related embodiment, the electrical contact element on the first surface is electrically connected to an electrical contact on the second surface through a plated via in the connector substrate.

In another embodiment of the present invention, a USB connector is comprised of a printed circuit substrate, an external connection end of the printed circuit substrate with interconnection terminals for making a connection to a mating USB connector half, a USB housing precisely aligned to the external connection end and the interconnection terminals thereon, whereby the USB connector substrate is directly electrically and mechanically interconnected to an internal system board in an electronic device using a single piece, Neoconix PCBeam™ normal force LGA/LGA connector aligned to, and compressed with normal force between the USB connector substrate and the system board so as to make electrical interconnections between conductive terminals on the USB connector substrate and conductive terminals on an internal system board such as a mother board.

In another embodiment of the present invention, a printed circuit board has a plurality of conductive terminals on a first surface, forming a pattern of terminals matching the pattern of interconnection terminals on a external interface connector such as a surface mount or pin-in-hole USB socket, and a plurality of flexible, conductive spring contact elements on a second, opposing surface, where at least one of the conductive terminals on the first surface is electrically connected to at least one conductive spring contact element on the second surface, and a USB socket soldered onto the printed circuit to electrically interconnect the USB socket terminals to the printed circuit board terminals. The USB socket assembly is mounted onto a system printed circuit board of an electronic device, such as a mother board, by normal force compression of the USB socket assembly, thereby compressing the elastic, conductive spring contact elements against conductive terminals on the system printed circuit board.

In another embodiment of the present invention, a standard USB connector socket is mounted to a rigid printed circuit board using surface mount soldering to form interconnections to terminals on a first surface of the printed circuit board. The second, opposing surface of the printed circuit board has a plurality of surface emanating, flexible conductive spring elements, where at least one of the terminals on the first surface of the printed circuit board is electrically connected to at least one of the flexible, conductive spring elements on the second surface of the printed circuit board through conductive vias in the printed circuit board substrate. The USB socket assembly is mounted onto a system printed circuit board of an electronic device, such as a mother board, by normal force compression of the USB socket assembly, thereby compressing the elastic, conductive spring contact elements against conductive terminals on the system printed circuit board.

In another embodiment of the present invention, a standard USB connector socket having external terminal connections for connection to a mating USB connector half, is mounted to a flexible printed circuit (FPC) substrate using surface mount soldering to form interconnections to terminals on a first surface of the FPC. The second, opposing surface of the FPC has a plurality of surface emanating, flexible conductive spring elements, where at least one of the terminals on the first surface of the FPC is electrically connected to at least one of the flexible, conductive spring elements on the second surface of the FPC. The USB socket assembly is mounted onto a system printed circuit board of an electronic device, such as a mother board, by normal force compression of at least the portion of the FPC bearing the flexible, conductive spring elements, thereby compressing the elastic, conductive spring contact elements against conductive terminals on the system printed circuit board to form electrical interconnections from the USB external terminal connections. In a preferred embodiment, a rigid stiffener is applied to the first surface of the FPC opposite the flexible, conductive spring elements, to facilitate application of uniform normal force to compress the spring contacts and mate to the conductive terminals on the system printed circuit board. In another embodiment, the conductive spring elements are Neoconix PCBeam spring contacts as taught in Neoconix patent publications, including U.S. Pat. Nos. 7,371,073 B2 and 8,584,353.

In a related embodiment, the USB connector socket on the first surface of the FPC does not overlie the flexible, conductive spring elements on the second surface, but rather the USB connector is offset from the conductive spring elements.

In another embodiment of the present invention, a standard USB connector socket is mounted to a rigid printed circuit board using pin in hole soldering to form interconnections to vias on the printed circuit board, forming a USB socket assembly. The second, opposing surface of the printed circuit board has a plurality of surface emanating, flexible conductive spring elements, where at least one of the terminals on the first surface of the printed circuit board is electrically connected to at least one of the flexible, conductive spring elements on the second surface of the printed circuit board. The USB socket assembly is mounted onto a system printed circuit board of an electronic device, such as a mother board, by normal force compression of the USB socket assembly, thereby compressing the elastic, conductive spring contact elements against conductive terminals on the system printed circuit board.

In another embodiment of the present invention, a Neoconix PCBeam connector has an array of solder pads on a first surface, and an array of PCBeam conductive, elastic contact elements on an opposing, second surface. At least one of the solder pads on the first surface is electrically interconnected to at least one PCBeam spring contact on the second, opposing surface by conductive traces and conductive vias. A USB connector socket is mounted on the first surface of the Neoconix PCBeam connector and interconnected electrically and mechanically using surface mount soldering processes. The resulting USB connector assembly is interconnected to an electronic system by normal force compression of the connector to mate the elastic, conductive PCBeam spring contacts on the second surface to conductive terminal pads on a system board, such as the mother board, in an electronic system. In another embodiment o*f the present invention, a Neoconix PCBeam connector has an array of solder terminals on a first surface, the solder terminals comprising capture pads for plated through holes, and an array of PCBeam conductive, elastic contact elements on an opposing, second surface. At least one of the solder terminals on the first surface is electrically interconnected to at least one PCBeam spring contact on the second, opposing surface by conductive traces and conductive vias. A USB connector socket is mounted on the first surface of the Neoconix PCBeam connector and interconnected electrically and mechanically using pin in hole soldering processes. The resulting USB connector assembly is interconnected to an electronic system by normal force compression of the connector to mate the elastic, conductive PCBeam spring contacts on the second surface to conductive terminal pads on a system board, such as the mother board, in an electronic system.

In another embodiment of the present invention, a USB connector is mounted on and electrically connected to conductive terminals on a first surface of a planar, normal force connector. The terminals on the first surface are electrically interconnected to normal force spring contacts on a second, opposing surface of the connector, and the USB connector is electrically connected to a system board in an electronic device, such as the mother board, by actuating the normal force connector to electrically and mechanically interconnect the conductive spring elements to conductive terminals on the system board. In a related embodiment, the normal force connector is actuated by screwing it down to the system board. In a related embodiment, the normal force connector has cantilever beam-like conductive spring contacts emanating from the second surface of the connector.

In another embodiment of the present invention, a USB connector socket assembly in an electronic device is electrically interconnected to the system boards of that electronic device with a single separable connector interface.

In another embodiment of the present invention, a standardized USB connector for use in an electronic device utilizes a single, direct electrical interconnection interface between the USB connector and the mother board, where the direct electrical interconnection is separable, re-mountable and re-connectable. In a related embodiment, the single, direct electrical interconnection is a single piece connector. In a further embodiment, the single piece connector is a normal force connector.

In another embodiment of the present invention, a standardized USB connector or other external interface connector for use in an electronic device utilizes a single, direct electrical and mechanical interconnection interface between the USB connector and the mother board, where the direct electrical and mechanical interconnection is separable, re-mountable and re-connectable, and whereby this interconnection provides the necessary alignment and retention of the USB connector to the connection ports or openings in the case of the electronic device. In a related embodiment, a standardized USB connector in an electronic device utilizes a single, direct electrical interconnection interface to a system board such as a mother board, whereby the direct electrical interconnection is separable, re-mountable, and re-connectable to both the USB connector substrate and to the mother board. In a further embodiment, the single electrical interconnection interface consists of a one piece connector that provides a separable interconnection that is re-mountable and re-connectable. In a related embodiment, the single electrical interconnection interface consists of a one piece, normal force connector that provides a separable interconnection that is re-mountable and re-connectable. In a related embodiment, the single electrical interconnection interface consists of a one piece, normal force connector that is mated and actuated using a screw to apply force to compress the springs of the connector against mating terminals on the USB connector substrate and/or on the mother board. In a further embodiment, registration features align the connector to the USB connector substrate and the mother board or daughter card, and prevent the connector from rotating while it is being compressed using the screw. In a related embodiment, the single electrical interconnection interface consists of a one piece, normal force connector that is mated and actuated using a spring-loaded clamp to apply force to compress the springs of the connector against mating terminals on the USB connector substrate and/or on the mother board, where registration features integral to the connector and the mating USB connector substrate and the mother board align the connector to the USB connector substrate and the mother board.

In another embodiment, an external interface connector assembly in an electronic device, such as a USB connector assembly, consists of an external interface connector that is electrically and mechanically connected to a small printed circuit substrate using soldering methods, such as surface mount assembly or pin in hole assembly, where the printed circuit substrate is attached and interconnected to an internal system board, such as a mother board, using a single connector. In a related embodiment, the single connector provides a separable, re-mountable and re-connectable interconnection. In a further embodiment, the single connector is a one piece connector. In a further embodiment, the single connector is a surface mount, normal force connector.

In another embodiment of the present invention, a USB connector assembly is interconnected to a system board, such as a mother board, using a single connector which is a one piece connector having a first surface adapted for soldering the connector to connection terminals on a circuit substrate such as a printed circuit board using a surface mount process, and a second surface providing a separable, re-mountable and re-connectable electrical and mechanical interconnection to a second circuit substrate.

In another embodiment of the present invention, an external interface connector for an electronic system, such as a standardized USB connector for use in an electronic device utilizes a single, direct electrical interconnection interface to a mother board, where the single electrical interconnection interface provides a separable, re-mountable, re-connectable electrical connection interface comprised of conductive elastic spring contacts integral to and emanating from a first surface of a planar substrate in the USB connector assembly. In a related embodiment, the elastic spring contacts are integral to a substrate onto which the USB connector is mounted. In another embodiment, the USB is mounted onto a substrate using pin in hole or surface mount soldering, and the integral spring contacts are cantilever beam-like spring contacts, and can be made of an electrically conductive spring material, such as copper-beryllium alloy, or a copper-nickel-tin alloy, and whereby the thickness of the spring material is between 0.0005″ and 0.010″, and preferably between 0.001″ and 0.003″. In a preferred embodiment, the predominate grain direction of the spring material is oriented longitudinally along the direction of the length of the elastic cantilever beam-like spring contact.

In another embodiment, the elastic spring contacts comprise an array of three dimensional elastic metallic contacts on the USB connector substrate, one or more of the contacts comprising an integral base portion and only one elastic arm; the base portion of the contact adhered directly to the USB connector substrate; the base of a contact electrically connected to a trace or terminal on the USB connector substrate; and the contact electrically interconnected within or on the USB connector substrate to at least one terminal of the USB connector that interfaces to external devices. In a related embodiment, the elastic spring contacts are patterned and formed into three-dimensional spring contacts from a sheet or strip of conductive spring material using batch patterning methods such as pattern etching or stamping, and batch shaping processes such as forming, while the contacts are still attached to, and integral with, the sheet or strip of conductive spring material. In another related embodiment, the elastic spring contacts are patterned and formed into three-dimensional spring contacts from a sheet or strip of conductive spring material using batch patterning methods such as pattern etching or stamping, and batch shaping processes such as forming, while the contacts are still attached to, and integral with, the sheet or strip of conductive spring material; and whereby the elastic spring contacts are attached to, and electrically interconnected with, the USB connector substrate while also still integral with the sheet or strip, and whereby one or more of the elastic spring contacts are subsequently singulated so as to no longer be integral with the contact sheet or strip and thereby be electrically isolated from the other elastic spring contacts.

In another embodiment, an external electrical interface for an electronic device, such as a USB connector interface, utilizes a single, separable electrical interconnection interface to a daughter card in the electronic device.

In another embodiment, an external electrical interface for an electronic device, such as a USB connector interface, is surface mounted on a rigid, PCB that directly interfaces electrically and mechanically to a motherboard or daughter card using a single, separable, re-mountable and re-connectable electrical interconnection interface.

In another embodiment, an external electrical interface for an electronic device, such as a USB connector interface, is surface mounted onto a flexible printed circuit that directly interfaces electrically to a motherboard or daughter card using a single, separable, re-mountable and reconnectable electrical interconnection interface.

In another embodiment, an external electrical interface for an electronic device, such as a USB connector interface for an electronic device such as a desktop computer, laptop computer, tablet, and/or mobile phone, and consisting of standardized male electrical interconnection terminals for USB 2.0, 3.0, and/or 3.1 on a printed circuit card whereby the female housing for the USB connector consists of a precision opening in the case of the electronic device, and whereby there is a single electrical, separable, re-mountable and re-connectable interconnection interface between the USB connector substrate and the motherboard in the device.

In another embodiment, an external electrical interface for an electronic device, such as a USB connector interface for an electronic device such as a desktop computer, laptop computer, tablet, and/or mobile phone, consisting of standardized male electrical interconnection terminals for USB 2.0, 3.0, and/or 3.1 on a printed circuit card whereby the female housing for the USB connector consists of a precision opening in the case of the electronic device, and whereby there is a single electrical and mechanical interconnection interface between the USB connector substrate and the motherboard in the device, and whereby the electrical and mechanical interconnection is separable, re-mountable and re-connectable.

A series of figures is provided to illustrate some, but not all, embodiments of the present invention.

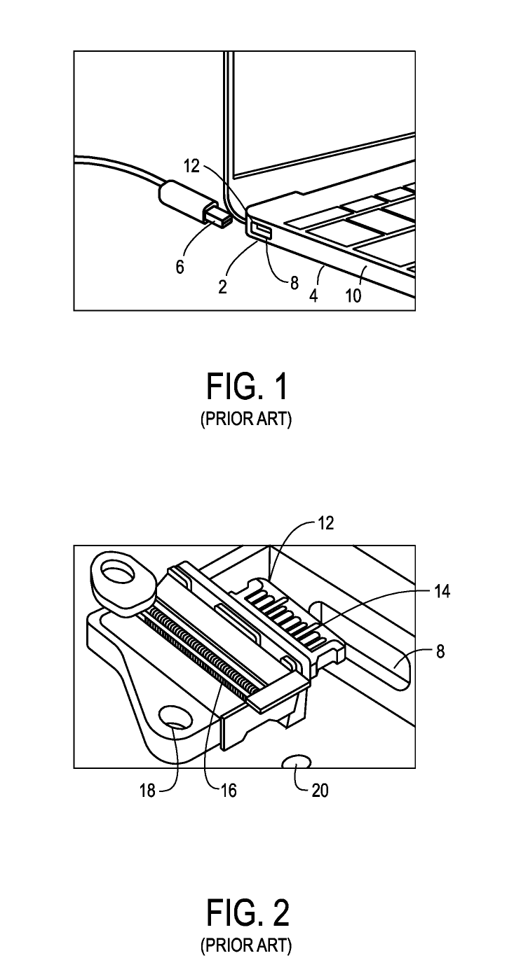

FIG. 1 is a photograph showing an external interface connector 2 for a laptop computer 4, of the type commonly known as a universal serial bus (USB) connector. In this figure, an external electronic device, such as a flash drive or other device connected by a USB cable, can be interconnected to the laptop computer. The USB connector can also, if needed, provide power to or from the external electronic device. In this prior art example, the USB receptacle in the laptop computer utilizes a precisely dimensioned opening 8 in the case or shell 10 of the computer as the housing for the USB receptacle, to guide alignment of the USB plug 6 from the external electronic device when connecting it to the laptop. The USB connector has a substrate or ‘tongue’ 12 upon which reside conductive interconnection terminals that form electrical interconnections to terminals in the USB plug 6 from the external device.

FIG. 2 is a photograph showing the internal structure and interconnections of the prior art USB connector shown in FIG. 1. The substrate 12 of the USB connector has been disconnected from the laptop computer and removed from laptop case opening 8 after removal of a mounting screw from USB connector screw hole 18 and laptop case screw hole 20. Conductive interconnection terminals 14 can be observed on the substrate 12. The terminals 14 on substrate 12 are electrically interconnected to connector 16. Connector 16 is half of a two-piece connector that snaps together to form electrical interconnections to internal system boards of the laptop computer, such as the mother board.

FIG. 3 is a photograph showing another internal view of the prior art USB connector from FIG. 1. In this view, the USB connector assembly 22 is still screwed into the case 10. Internal connector half 16 has been separated from mating connector half 24 which forms an interconnection to flex cable 26, which in turn is connected using another two piece connector to a system board, such as a mother board. This interconnection utilizes multiple interconnection interfaces, and multiple connectors, and hence has limitations in terms of signal integrity, data transfer speeds, and power handling. In addition, the many components add cost and complexity to the fabrication and assembly of the USB connector internal connections to electronic device.

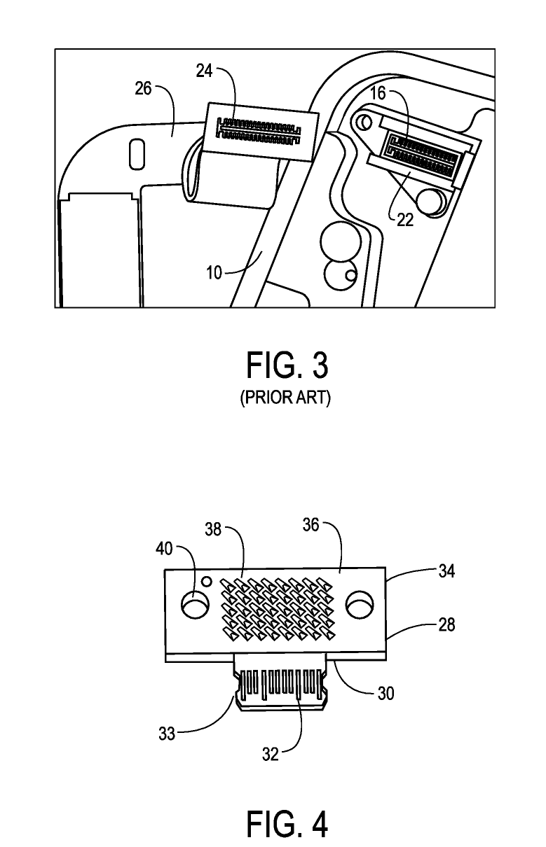

FIG. 4 is a drawing showing a perspective view of one embodiment of the present invention. USB connector component 28 consists of a USB connector substrate 30, which is analogous to substrate 12 in the prior art USB connector shown in FIG. 2, and which could be considered the ‘male’ half of the USB connector. Conductive terminals 32 reside on end 33, which could be called a ‘tongue’, of substrate 30, and serve as the interconnection terminals that form an electrical interconnection to conductive mating terminals a mating USB connector half (such as a female USB connector half). In most cases, conductive terminals 32 will reside on both a first surface and a second surface of substrate 30 end 33. Substrate 30 increases in width in the area away from terminals 32, and can form the approximate shape of a letter T, although it can also comprise other shapes, and the widening shown is not required in this invention. The widened area of the substrate contains on a first surface 36 a plurality of conductive, elastic spring contacts 38, and screw holes 40 for screwing down the USB connector assembly 28 to mate it to a system board or component in the electronic device. In one embodiment of the present invention, the spring contacts 38 are interconnected to conductive terminals on a mating circuit substrate, such as a system board, by applying normal force to the interconnections through the substrate 28 One or more of the conductive, elastic contacts 38 are electrically interconnected to conductive interconnection terminals 32 on USB substrate 30 through conductive traces and, in the case of terminals 32 on the second surface of connector component 28, through one or more conductive vias in the substrate 30. The conductive, elastic contacts 38 can be of a variety of spring types, but in a preferred embodiment they are shaped similarly to a cantilever beam. Contacts 38 are intended to form a direct electrical interconnection to a system board in the electronic device, such as a mother board or a daughter card. Alternatively, the interconnection could be made to a flexible printed circuit. In the embodiment of the present invention shown in FIG. 4, there can be a single contact interface from the USB external connections to the system board, potentially providing substantially improved signal integrity at high data transfer speeds, easier and less costly integration into the electronic device, higher reliability due to fewer interfaces, and higher power handling capacity.

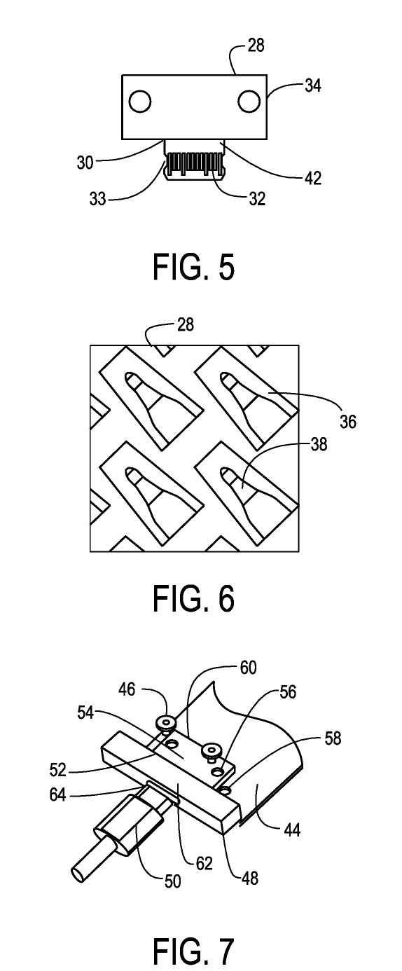

FIG. 5 is a drawing showing the second surface 42 of USB connector component 28. Conductive USB interconnection terminals 32 reside on the second surface of end 33 of substrate 30, as well as on the first surface. The widened end of the connector 34 may have on its second surface a stiffening element to assist in applying uniform normal force to the conductive elastic contacts on the first surface of this end of the connector.

FIG. 6 is a drawing showing an expanded view of 4 of the plurality of conductive, elastic spring contacts 38 residing on a first surface 36 of USB connector substrate 28 as shown in FIG. 4. This figure shows an embodiment of the present invention where the elastic spring contacts 38 are cantilever beam-like springs, of the type known as PCBeam™ and taught in various US and international patents assigned to Neoconix, and as referenced previously. Other spring contact types can be used within the scope of the present invention.

FIG. 7 shows a drawing of a perspective view of one embodiment of the present invention showing a structure for integrating the USB connector substrate of the type shown in FIG. 4 into an electronic device. USB connector assembly 60 with a substrate 52 having on a second surface (facing up in this drawing) a stiffener 54 overlying an area on the first surface of the substrate having an array of conductive elastic spring contacts (not visible in this figure) as shown in FIG. 4. USB connector assembly 60 has screw holes 56, which align to screw holes 58 in an internal system board of the electronic device. Connector assembly 60 can be interconnected to the system board by compressing the elastic spring contacts on the first surface of substrate 52 against conductive electrical terminals on the system board 44 using normal force applied by the screws. Electronic device case 48 has an opening 64 to which end 62 of the USB connector substrate 52 is precisely aligned, so that the case may serve as a connector housing to assist in insertion of USB cable or device 50 to form an external electrical interconnection from an external electronic device to the system USB connector assembly 60.

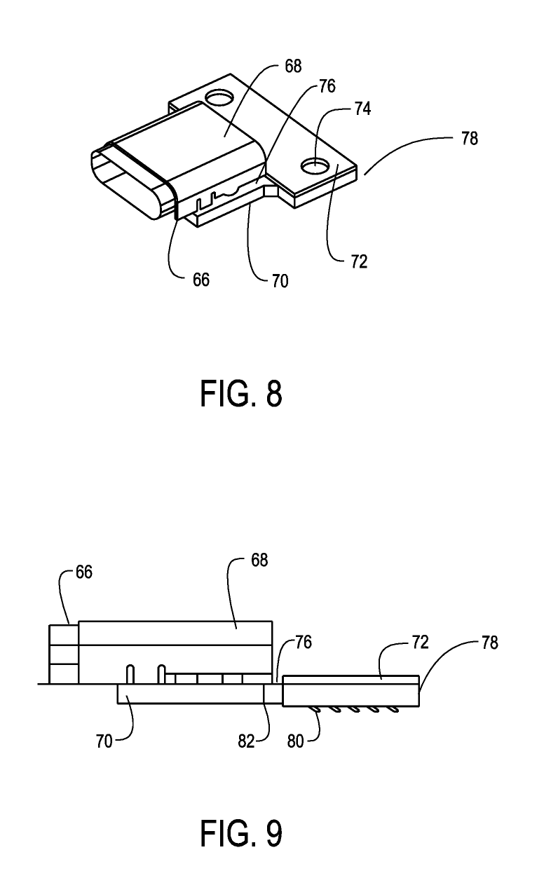

FIG. 8 shows a drawing of a perspective view of another embodiment of the present invention, whereby a USB connector socket 66 including the conductive terminals on a planar substrate or ‘tongue’ (not visible) and a formed metal housing 68 surrounding it to enable accurate alignment of a mating USB connector half (not shown) to it, are mounted on and electrically interconnected to a second surface 76 of a printed circuit substrate 70. On an end 78 of printed circuit substrate 70 there may reside a stiffener 72 and screw holes 74. On the first surface of substrate end 78 there resides a plurality of conductive, elastic spring contacts (not visible on underside of substrate as drawn), at least one of which is electrically connected to a USB terminal for external interconnection to a mating USB interface.

FIG. 9 shows a drawing of a profile view of the USB connector structure shown in FIG. 8. a USB connector socket 66 including the conductive terminals on a planar substrate or ‘tongue’ (not visible) and a formed metal housing 68 surrounding it to enable accurate alignment of a mating USB connector half (not shown) to it, are mounted on and electrically interconnected to a second surface 76 of a printed circuit substrate 70. On an end 78 of printed circuit substrate 70 there may reside a stiffener 72 and screw holes (not visible). On the first surface 82 of substrate end 78 there resides a plurality of conductive, elastic spring contacts 80, at least one of which is electrically connected to a USB terminal internal to the USB socket or housing, for external interconnection to a mating USB interface.

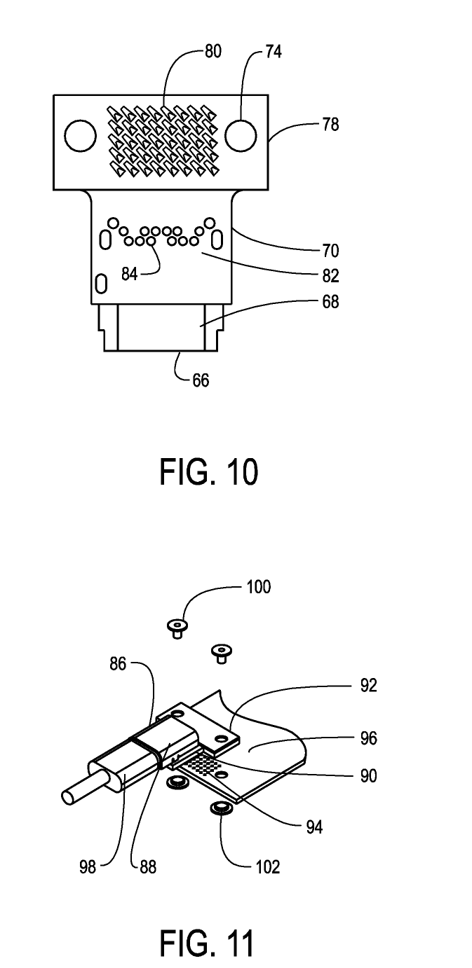

FIG. 10 shows a drawing of a bottom view of the USB connector structure shown in FIG. 8. USB connector socket 66 including metal housing 68 is mounted on a second surface of printed circuit substrate 70, using surface mount soldering, pin in hole soldering, or other electrical and mechanical interconnection means. A first surface 82 of substrate 70 at substrate end 78 has a plurality of conductive elastic spring contacts 80, one or more of which is electrically interconnected to the solder pads or through holes 84 to which the USB connector socket 66 is soldered, and through that connection is electrically interconnection to the external, conductive interconnection terminals of the USB connector socket.

FIG. 11 shows a drawing of a perspective view of the USB connector assembly shown in FIG. 8 as it may be interconnected to a system board in an electronic device, using a separable interface comprised of an array of conductive, elastic spring contacts that can be connected to conductive terminals on a mating circuit substrate using application of normal force. Connector assembly 86 has USB receptacle and formed housing 88 mounted onto and interconnected electrically to circuit substrate 90. End 92 of circuit substrate 90 has on a first surface (bottom side as drawn) an array of conductive, elastic spring contacts (not visible as they are on underside of substrate in this drawing, see FIG. 10 item 80), which are interconnected electrically to conductive terminal pads array 94 on system printed circuit board 96. An external device is interconnected to the USB receptacle 86 through USB mating half or plug 98. Normal force compression to interconnect spring contacts 80 to system board terminal pad array 94 may be applied using screws 100 and nuts 102, or by other means such as clamping with a spring loaded clamp.

FIG. 12 shows a diagram of an array of 40 conductive, elastic spring contacts of the type shown in FIG. 10, for mating the USB connector assembly directly to a system board, and shows one possible configuration for assignment of the function of the various interconnection springs to allow high speed data transfer and power transfer with high signal integrity.

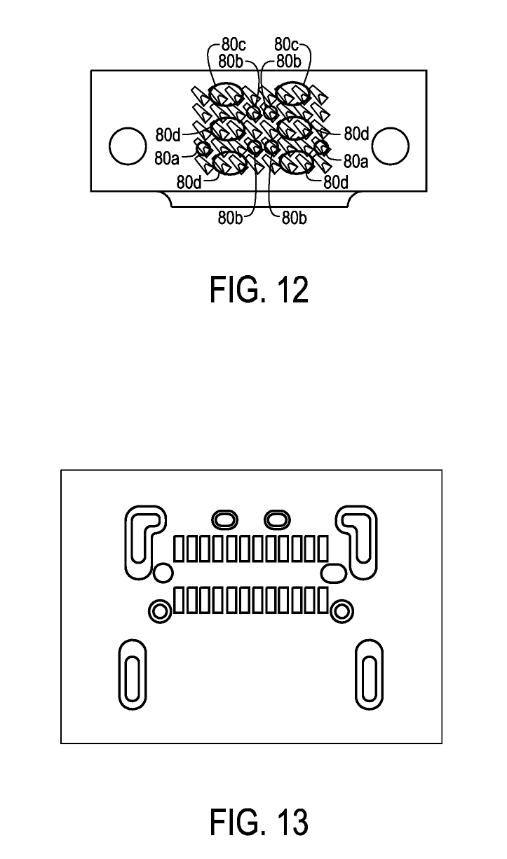

FIG. 13 shows one possible mounting footprint of conductive terminal pads for surface mounting of a USB 3.0 connector onto a substrate of the type shown in FIG. 8.

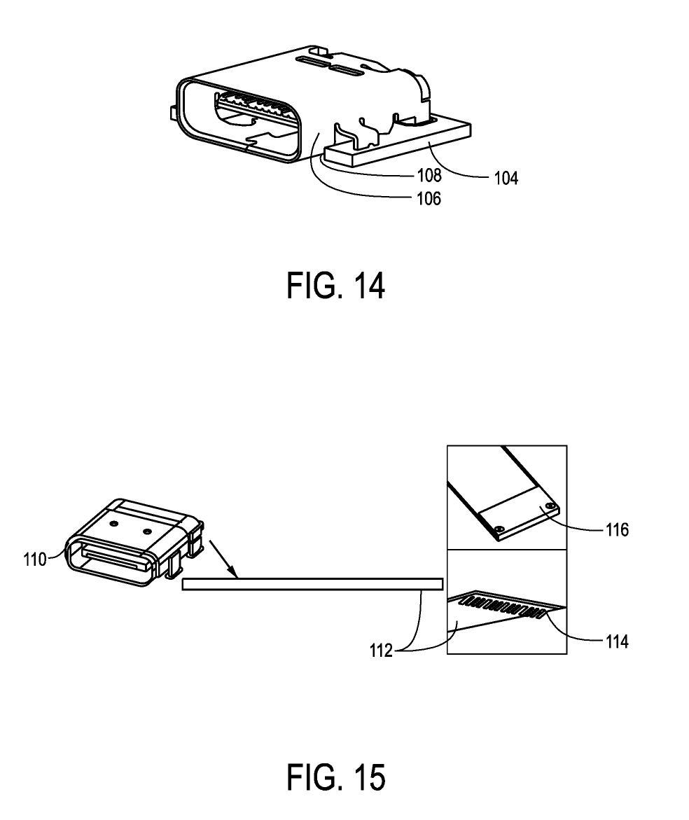

FIG. 14 shows an alternative configuration of the USB connector assembly shown in FIG. 8, whereby substrate 104 has a cut out 108 under the body of the USB connector housing, such that the USB connector can be mounted to the substrate with a reduced total profile height, to better fit in thin, low profile electronic devices such as cell phones.

FIG. 15 shows a drawing of a perspective view of an alternative embodiment of the present invention, whereby a USB connector socket 110 is mounted on and soldered to a flexible printed circuit 112. Flexible circuit 112 has on one surface a plurality of conductive, elastic spring contacts 114 which allow interconnection to conductive terminals on a system board in an electronic device. Uniform application of pressure to compress the contacts 114 onto the terminal pads may be enabled by a stiffener 116 on the opposing surface of the flex circuit from that which the springs are mounted on.

These figures illustrate only some of the embodiments of the present invention, and the invention is not limited to only those illustrations provided. Many modifications and adaptions of the preferred structure are possible without departing from the spirit of the present invention. Accordingly, the foregoing descriptions should be considered as merely illustrative of the principals of the present invention and not in limitation thereof, as the invention is defined by the following claims.

Having thus described the invention, what is claimed is:

1. An electrical connector for attaching an electrical component to another electrical device using an USB connector, the electrical connector comprising: a housing; a plurality of spaced electrical contacts, each spaced electrical contact being formed as a cantelevered arm attached at one end with the other end free and formed from an electrically-conductive material which has spring properties.

2. A method of making an electrical connector for connection of an electrical device to a USB connector comprising the steps of: forming a plurality of electrical contacts from a flat piece of electrically conductive material with spaced contacts in a location to engage contacts of the USB connector, forming the flat piece into a three-dimensional shape, singulating the electrical contacts and attaching the contacts to the electrical device to allow connection of the device to the USB connector.

3. A method including the steps of claim 2 and further including the step of coating a portion of the contact with a conductive material to improve the conductivity of the contact.
